(19) United States
(12) Patent Application Publication
(10) Pub. No.: US 2023/0035593 A1
(43) Pub. Date: Feb. 2, 2023

(54) EMERGENCY NOTIFICATION SYSTEM AND METHOD

(71) Applicant: Juan Gilberto Cano, Weslaco, TX (US)

(72) Inventor: Juan Gilberto Cano, Weslaco, TX (US)

(21) Appl. No.: 17/878,379

(22) Filed: Aug. 1, 2022

Related U.S. Application Data
(60) Provisional application No. 63/228,342, filed on Aug. 2, 2021.

(51) Int. Cl. G08B 21/02; G06F 3/0488; H04N 5/76; G06F 3/0481; H04N 5/232; H04W 4/90

(52) U.S. Cl. CPC G08B 21/0269; G06F 3/0488; H04N 5/76; G06F 3/0481; H04N 5/232; H04W 4/90

(57) ABSTRACT

An emergency notification system and method includes a mobile computing device having live transmissible location data and activation means for selectably transmitting an emergency signal, such as at least one touch activatable emergency button provided through a touchscreen display of the mobile computing device. When the user activates an emergency button, GPS location data from a GPS receiver of the mobile computing device may be automatically acquired. A video and/or audio recording may also be generated using a camera of the mobile computing device. The recorded video and location data is automatically transmitted from the mobile computing device to a remote data storage location and to an administrator who may provide emergency assistance to the user.

### RELATED APPLICATION

This application claims the benefit of U.S. Provisional Application No. 63/228,342, filed on Aug. 2, 2021.

### FIELD OF THE INVENTION

The present invention generally relates to alert systems. More particularly, the present invention relates to an emergency notification system and method, such as a criminal victim identification and safety alert system.

### BACKGROUND OF THE INVENTION

Violent crime, including domestic violence, sexual violence and stalking, continues to be a problem in the United States. On average, twenty-four people per minute are victims of rape, physical violence or stalking by an intimate partner in the United States. One in four women (24.3%) and one in seven men (13.8%) aged eighteen and older in the United States have been a victim of severe physical violence by an intimate partner in their lifetime. Almost half of all women and men in the United States have experienced psychological aggression by an intimate partner in their lifetime. Domestic violence issues lead to nearly eight million lost days of paid work each year.

Nearly one in five women (18.3%) and one in seventy-one men (1.4%) have been raped in their lifetime. Nearly one in ten women (9.4%) in the United States have been raped by an intimate partner in their lifetime. More than half of female victims of rape reported being raped by an intimate partner and over forty percent reported being raped by an acquaintance.

Stalking can be defined as feeling fearful or believing that they, or someone close to them, will be harmed or killed by someone following them or by unwanted and/or repeated surveillance. One in six women (16.2%) and one in nineteen men (5.2%) in the United States have been a victim of stalking at some point during their lifetime. Two thirds of female stalking victims were stalked by current or former intimate partners. Men who were stalked were primarily stalked by partners or acquaintances.

Calling for help is sometimes not an option when the perpetrator is within close range of the victim. Moreover, in some cases, calling law enforcement can actually escalate the situation as it upsets the perpetrator.

It is known that domestic violence calls are high-risk calls for law enforcement. These situations have a tendency to turn violent and dangerous within seconds. In other instances, law enforcement, anticipating a potentially dangerous situation, overreact before being able to properly ascertain the situation, causing unnecessary injury or even death.

Many rape and domestic violence crimes go unprosecuted. It can be difficult to prove that the intimate partner committed such violence. Oftentimes, the victims are re-victimized by law enforcement, investigators, advocates and prosecutors and the like as they have to prove that they have been a victim of a crime. In other cases, there is insufficient evidence to move forward with criminal charges.

Accordingly, there is a continuing need for an effective emergency notification or safety alert system. Such safety alert system should be able to be used discreetly. Such safety alert system should also be capable of identifying the perpetrator, the location of the victim, and the circumstances of the situation to assist responding law enforcement and criminal prosecutors. The present invention fulfills these needs, and provides other related advantages.

### SUMMARY OF THE INVENTION

The present invention is generally directed to an emergency notification system and related method. The system and method of the present invention enables a user to utilize the notification system safely and discreetly. The notification system may also be used to identify the perpetrator, the location of the victim, and assist responding law enforcement, including with identifying the lethality of the situation, as well as provide criminal prosecutors with evidence.

The emergency notification system in accordance with the present invention generally comprises a mobile computing device having live transmissible location data and activation means for selectively transmitting an emergency signal. A video and/or audio recorder is associated with the mobile computing device. Means are provided for automatically activating the video and/or audio recorder when transmitting an emergency signal. Means are also provided for automatically accessing GPS location data from a GPS receiver of the mobile computing device. After a predetermined period of time following initial transmission of the emergency signal, recorded video and/or audio data and location data of the mobile computing device is automatically transmitted from the mobile computing device to a remote data storage location.

The system includes means for tracking the location of the mobile computing device by periodically automatically obtaining GPS location data through the GPS receiver of the mobile computing device and transmitting the GPS location data to an administrator computing device. The activation means of the system may comprise at least one touch activatable button through a touchscreen of the mobile computing device. The at least one touch activatable button may be activated by the user to report to administrator computer that a crime is being committed in real time, that the user is lost or being followed, and/or that the user or a person with the user is having a medical emergency.

The system includes means for inputting and storing on the mobile computing device user emergency contacts, and automatically sending an alert to the user emergency contacts when the emergency signal is transmitted.

The system may also include means for inputting and storing protective order information on the mobile computing device and automatically notifying when the protective order expires.

In accordance with the present invention, at least one touch activatable emergency button is provided through a touchscreen display of a mobile computing device. When the at least one emergency button is touched and activated, GPS location data from a GPS receiver of the mobile computing device is automatically acquired. The GPS location data of the mobile computing device is automatically transmitted from the mobile computing device to an administrator computing device. The mobile computing device may be tracked by periodically automatically obtaining GPS location data through the GPS receiver of the mobile computing device and transmitting the GPS location data to the administrator computing device.

A video using the camera of the mobile computing device may automatically begin recording upon a user touching and activating the at least one emergency button. After a predetermined period of time, the mobile computing device automatically transmits to an administrator computing device the recorded video. The recorded video may be received by the administrator computing device on a storage medium physically separate from the mobile computing device. Preferably, the audio and video go directly to the administrator, preserving chain of custody.

The at least one emergency button may be activated by the user to report a crime in real time, including a crime committed upon the user. The at least one emergency button may be touched and activated by the user when the user is lost. The at least one emergency button may be touched and activated by the user when the user or a person with the user is having a medical emergency. The at least one emergency button may be touched and activated by the user when the user or person with the user is concerned about being followed.

The user may input and store on the mobile computing device user emergency contacts. An alert may be automatically sent to the user emergency contacts when the user activates the at least one emergency button, which may include GPS coordinates from where alert was initiated from.

Emergency assistance may be provided to the user when the user activates the at least one touch activatable emergency button.

A touch activatable button may be provided through the touchscreen display of the mobile computing device that the user may activate to transmit a message to the administrator computer that the user is safe.

Protective order information may be inputted and stored on the mobile computing device. The user may be automatically notified when the protective order expires.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is schematic diagram illustrating various components of the system of the present invention;

FIG. 2 is a screenshot of a registration screen used in accordance with the present invention;

FIG. 3 is a screenshot of a login screen used in accordance with the present invention;

FIG. 4 is a screenshot illustrating a menu used in accordance with the present invention;

FIG. 5 is a screenshot depicting victim information used in accordance with the present invention;

FIG. 6 is a screenshot depicting perpetrator information used in accordance with the present invention;

FIG. 7 is a screenshot depicting a screen on a mobile computing device, in accordance with the present invention;

FIG. 8 is a diagrammatic illustration of a screenshot depicting video taken in accordance with the present invention;

FIG. 9 is an image of a screen of an administrator or law enforcement computer used in accordance with the present invention;

FIG. 10 is a depiction of an administrator or law enforcement mobile electronic device incorporating the present invention; and

FIG. 11 is an image of a screenshot depicting a screen on a mobile computing device, in accordance with the present invention.

### DETAILED DESCRIPTION OF THE PREFERRED EMBODIMENTS

As shown in the accompanying drawings, for purposes of illustration, the present invention resides in an emergency notification system and related method. The system and method of the present invention may be used, for example, as an alert safety system, such as when a crime is committed, such as against a user of the present invention. The present invention enables a victim to report a crime and provide important information and evidence to law enforcement and in some cases receive emergency assistance, as necessary.

Every year thousands of crimes go unreported due to victim's fearing retaliation from a perpetrator. When crimes are reported, victims or witnesses often live in fear of the day the perpetrator is released from custody. The system of the present invention makes it quick and easy to alert and report the perpetrator if he or she retaliates. The system of the present invention provides individuals with an advanced tool for safety with multiple applications as an added layer of protection. The system provides mobile safety solutions for all segments of the population, including individuals, organizations, schools, law enforcement and more. The system of the present invention is specifically designed to summon help in the event of any type of emergency, interfacing with law enforcement agencies, and enhancing a greater level of personal safety for a safer society.

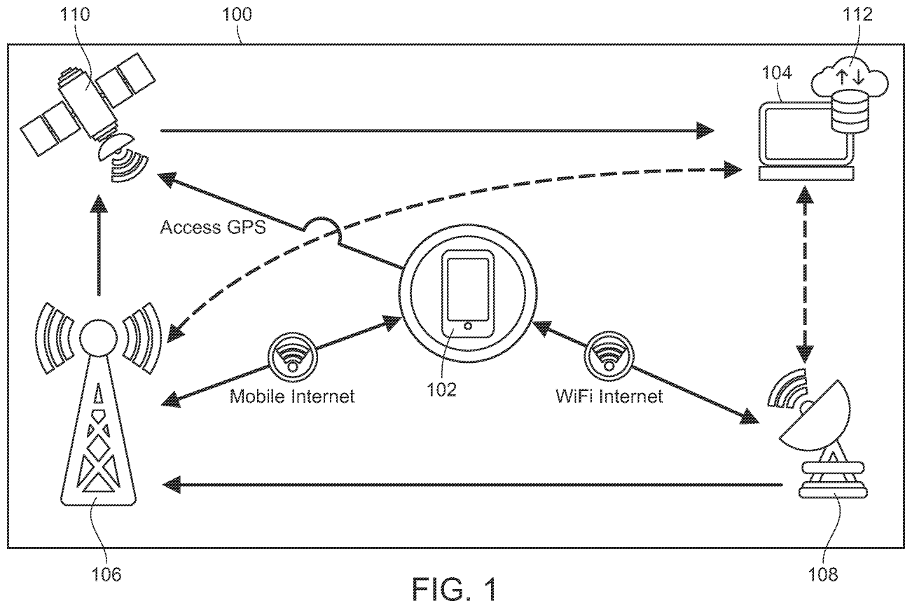

With reference now to FIG. 1, a diagram of an exemplary system 100 embodying the present invention is shown. In accordance with the invention, a user utilizes a mobile computing device 102, such as a smartphone or other handheld device. The mobile computing device 102 has a video and/or audio recorder, such as a smartphone camera, associated with the mobile computing device. The mobile computing device 102 also has a GPS receiver for enabling access of GPS location data from the mobile computing device 102. The mobile computing device 102 also has means for inputting and storing information and software applications and the like. Preferably, the mobile computing device has a touchscreen display screen which enables a user to touch activate buttons displayed on the display screen.

The mobile computing device 102 is capable of being in wireless electronic communication with an administrator computing device 104, such as at offices of an administrator or of law enforcement, such as a dispatcher or the like. This may be achieved by an existing wireless network through which the mobile computing device 102 communicates, such as a mobile interface with cell phone towers 106 or the like. Additionally, or alternatively, the mobile computing device 102 may utilize a Wi-Fi connection with the antenna 108 in FIG. 1 representing Wi-Fi components, including, but not limited to, a wireless router, wireless access points, network interface cards, a wireless bridge or repeater, routers, a wireless LAN antenna, etc. In some cases, the mobile computing device 102 may communicate wirelessly with a satellite-based system 110 which is used as, or part of, the wireless network for communicating between the mobile computing device 102 and administrator computing device 104. GPS data, however, is received by the mobile computing device 102, such as by a GPS receiver of the mobile computing device 102, from one or more satellites 110, which information is used to locate or even track the location of the mobile computing device 102, and thus the user who is in an emergency situation. As will be more fully explained herein, the mobile cellular towers and/or network 106, Wi-Fi network, and/or satellite system 110 communicates various pieces of information from the mobile computing device 102 to the administrator computing device 104 as initiated by the user of the mobile computing device 102 when utilizing the present invention.

The software application used in accordance with the present invention may be downloaded onto the mobile computing device 102 and/or administrator computing device 104 by a variety of means, including utilizing the Google Play Store, Apple App Store, or other platforms. The software may run on Android, iOS, and web platforms. The software may utilize third-party interfaces to provide various services, including Google Map service to display reported coordinates on a map, save reports, videos and audio files, send alerts, such as text alerts via SMS or the like, etc.

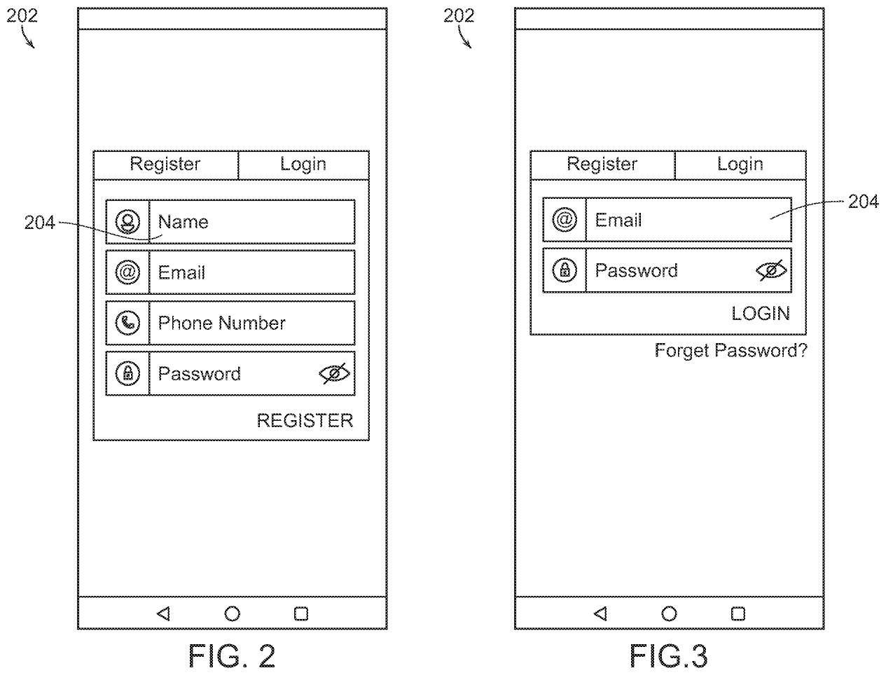

Once the software is downloaded onto the mobile computing device 102, the user registers the software, such as by entering his or her name, email address, phone number, sets up a password or the like, as illustrated in FIG. 2. In order to utilize the software, the user may log in, such as illustrated in FIG. 3, by providing the user's email and password or other identifying information, access codes or the like. The touch display screen 202 of the mobile computing device 102, such as the user's smartphone, may be presented with windows 204 or other areas into which this information can be inputted, such as by use of a virtual or dedicated keyboard or the like.

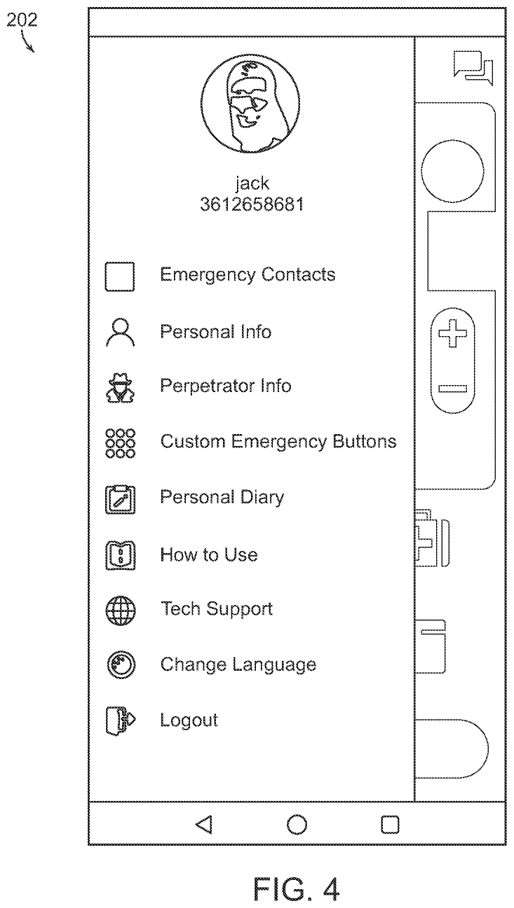

With reference to FIG. 4, the menu may include, as illustrated, a personal diary setting wherein the user can save time, dates, location and personal notes that he or she chooses to preserve as evidence of prior assaults, such as being admitted to the hospital, doctor visits, etc. The menu may also include a “how-to-use” button wherein the user may read about how to use the software application in an emergency situation, “technical support” relating to specifics of the application, or selecting a different language, if necessary. If the user changes devices or decides not to use the application anymore, the user may log out from the application.

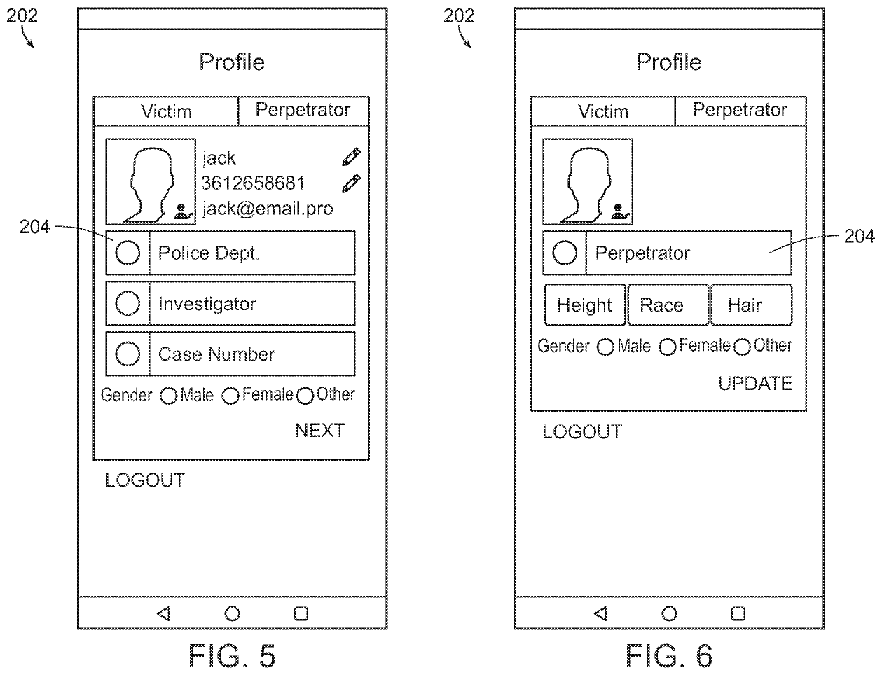

With reference now to FIG. 5, the user is able to add relevant personal information, such as when the user selects “Personal Info” from the menu, as shown in FIG. 4. Such information may include a picture of the user, the user's name, the user's telephone number, the user's email address, a residential address, a work address, or the gender of the user. All of this information can be helpful to the administrator and/or law enforcement personnel acting upon an emergency alert initiated by the user in the future. Such information, for example, can be used to contact the user, send law enforcement and/or medical assistance to the user, as needed, and to ensure that such law enforcement and medical personnel have information relating to the user so as to be able to distinguish the user from a criminal or others.

With continuing reference to FIG. 5, as part of the personnel information or profile of the user, if the user has been the victim of abuse, stalking, or some other crime, the user may also be able to input information relating to their prior recording of such one or more crimes. This can include the information relating to the police department and investigator who handled the incident, the case number assigned to the incident, etc. Additionally, or alternatively, the user's personal information or profile may be used to search for a registered law enforcement agency or the nearest law enforcement agency that a user's future emergency alert or notification may be sent to.

Once the user's profile information is completed, the user may tap on the “next” button, as illustrated in FIG. 5, which results in a screen being displayed to the user relating to a profile of a perpetrator or potential perpetrator so as to enter their information, such as name, race, gender, photograph, height, weight, hair and other descriptors which could be used by responding law enforcement to identify the perpetrator. Such windows for entering information are shown in FIG. 6, as an example. For example, if the user has been the subject of past domestic abuse and is no longer living with his or her spouse but fears future abuse, the user may input information relating to the spouse as a past perpetrator and potential future perpetrator. When law enforcement arrive to a future emergency alert, they will not only have information relating to the user or victim, but also potential identifying information relating to the perpetrator to assist them in effectively and safely handling the situation. The information entered into the profile section by the user could also indicate the severity of the past crimes, whether any weapons were used by the perpetrator, etc. in order to prepare law enforcement when responding to a call in response to an emergency alert initiated by the user. Typically, the information entered into the profile of a perpetrator or potential perpetrator is done by the user on the user's mobile computing device 102 having the application software thereon. This information may only be seen by the user on the software application.

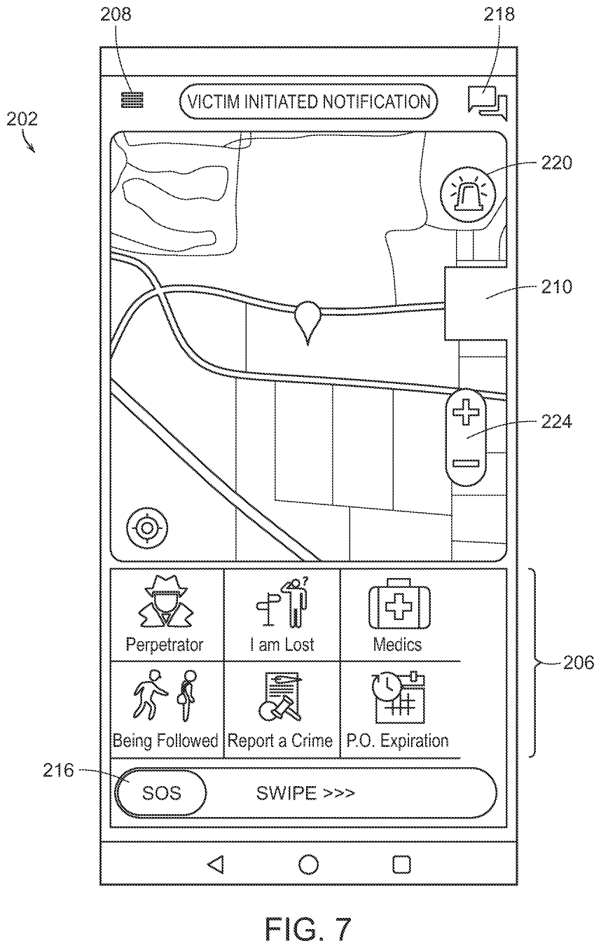

With reference now to FIG. 7, the system of the present invention has activation means for the user to selectively transmit an emergency signal to the administrator computing device, which may be a law enforcement agency, such as a law enforcement dispatcher or the like. For example, when the user opens and activates the software application on his or her mobile computing device a display will be shown on the screen 202 which provides several options to the user, as illustrated. These include displaying at least one touch activatable emergency button 206. As illustrated, the present invention contemplates a “perpetrator” emergency button, a “report a crime” button, a “being followed” emergency button, a “I am lost” emergency button, a “medical emergency” button, and/or a “protective order expiration” button. Such touch activatable emergency buttons 206 may be used to report a crime, whether against the user or a crime occurring near the user, if the user is concerned about being followed, concerned about being lost, needing medical care, etc.

The screen 202 may include a menu icon or button 208. When the user presses this icon or button 208, an application menu may be presented to the user, including application settings, emergency contacts and other options available on the application menu as shown on a screen pop-up, which may be similar to that illustrated in FIG. 4.

Pressing the protective order expiration button 206 may enable the user to enter information relating to an existing protective order. This information may include the expiration date of the protective order. The user may choose to protect his or her privacy and label this with a pseudonym or other non-identifying information in case the potential perpetrator views the user's mobile computing device. The information relating to the protective order expiration date may be entered and an alert set to remind the user of the protective order's expiration. This information can appear in a user's digital calendar on the mobile computing device and/or a pop-up message may be presented to the user to alert him or her of the upcoming expiration of the protective order. This gives the user an option to receive an alert before the protective order expires in the event another protective order needs to be obtained or so that the user can take extra precautions for his or her safety.

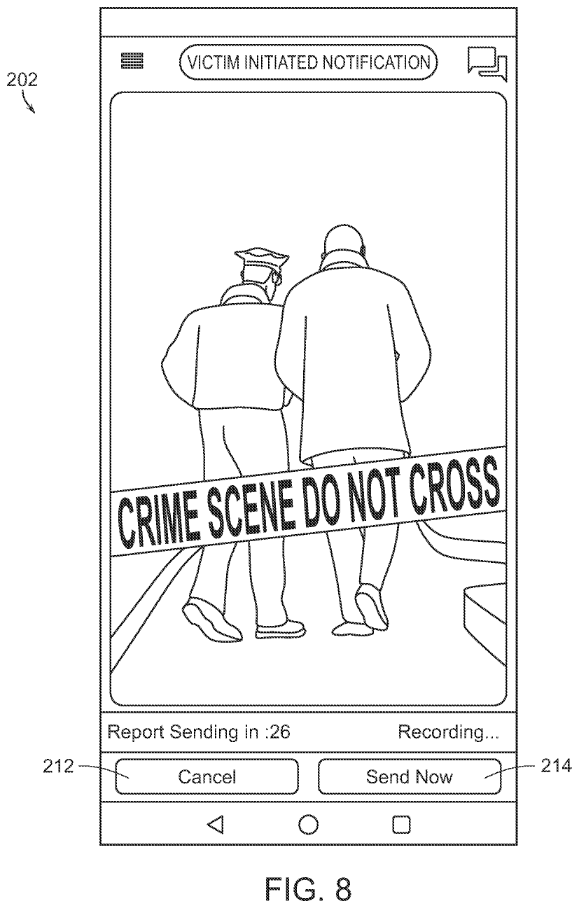

With continuing reference to FIG. 7, when a crime is being committed or is about to be committed against the user, such as by a perpetrator, the user activates the “perpetrator” emergency button 206 by pressing the button on the touchscreen display 202. Alternatively, the present invention may provide a floating widget button 210 which is a shortcut button to alert of a crime. Activating either of these buttons 206 or 210 causes the software application to automatically acquire GPS location data from a GPS receiver of the mobile computing device 102. It also causes the software application to automatically activate the video and/or audio recorder, such as the smartphone's camera to begin recording a video and/or audio in real time. Thus, the mobile computing device's camera automatically begins recording video of the scene, as can be illustrated in FIG. 8.

As shown in FIG. 8, in a particularly preferred embodiment, video and/or audio are recorded automatically for a predetermined period of time. Such may be, for example, a thirty second recording, although the time can vary. Preferably, the video/audio time is sufficiently long to record the scene and perpetrator but sufficiently short so that the video/audio file is quickly transmitted to the administrator. If the user inadvertently depressed one of the emergency buttons 206 or 210, or the user has changed his or her mind that a crime is being committed against them, the user may press a “cancel” button 212 which will cancel the recording and end any notification process. However, after the predetermined period of time, such as thirty seconds, the video with audio recording will be automatically sent to the administrator computing device 104.

Additionally, the acquired GPS location device will be sent to the administrator computing device 104 with the software application open and a relevant emergency button activated, means for tracking the location of the mobile computing device is activated. This is by periodically automatically obtaining GPS location data through the GPS receiver of the mobile computing device and transmitting the GPS location data to an administrator computing device. The administrator computing device will also have information available to it relating to the profile information of the user, any potential perpetrators, etc.

Thus, the video and audio recording, and additional information as described above will be automatically sent at the expiration of the timer unless it is cancelled by the user. This enables the user to record the scene as discretely as possible without the need of the user to open his or her camera, begin recording, manually ending the recording, and then taking the appropriate steps to save the recording and forward it to the administrator or law enforcement. Instead, with the mere touch of a button on the display screen, these events occur automatically so that the perpetrator is not aware that he or she is being recorded and such video and audio is being automatically sent to an administrator or law enforcement agency.

With continuing reference to FIG. 8, in the event that the user does not want to wait for the entire time period of the video recording to be made, the user may be presented an option to “send now” such as by pressing the “send now” button 214, which will immediately and automatically send however much video and audio has been recorded in a file as part of a report which may also include the user's name, email address, phone number, GPS live location information, time date and location where the alert was activated, to the administrator computing device 104. This may be done, for example, if the situation between the user and the perpetrator escalates. This may also be if the perpetrator discovers that the user is recording the perpetrator and event in real time.

When the report is sent, which may include the video and/or audio recording, such recording file and additional information is stored remotely from the user's mobile computing device 102, such as at the administrator computer 104 or site, or even on a remote cloud storage facility 112. Preferably, this occurs automatically and by default. Also, preferably, such video and audio recording is not stored on the user's mobile computing device 102. One reason for not storing the recorded video and/or audio is to protect the user from a perpetrator who may search the user's phone for any video or audio recording and who could act violently towards the user upon finding such recorded video or audio of the event. This also preserves the files and a record of the event regardless of the condition of the user's mobile computing device 102, which may be damaged or destroyed either during the crime or by the perpetrator afterwards.

When an emergency signal, such as an emergency alert report as described above, is sent from the user's mobile computing device 102 to the administrator computing device 104, the invention may simultaneously send an alert to the emergency contacts listed on the user's emergency contacts list and plan. The information provided to the emergency contacts may vary, and include the time and date when the alert was made, location data of when the alert was made or current location data of the user. Thus, family and friends are alerted to the situation and may be of assistance.

With reference again to FIG. 7, a touch activatable button, such as a “SOS” button 216 may be pressed or swiped to immediately report an emergency, such as a crime. Such may be used to report a crime being committed against the user, a crime feared to be committed upon the user, any crime, or even any emergency, such as a medical emergency. In use, the “SOS” button 216 sends the emergency signal alert instantly without sending the created audio and video file. GPS tracking of the user's mobile computing device 102 beings instantly and such information is relayed to the administrator computing device 104. Thus, the emergency signal alert is sent immediately, instead of waiting for a predetermined period of time for a video and/or audio recording to be initiated and made.

With continuing reference to FIG. 7, means may be provided for having real-time communication between the user, through his or her mobile computing device 102 and an administrator or law enforcement personnel, such as through the administrator computing device 104. Such may comprise a chat icon or button 218, which can be pressed by the user to initiate real-time communication with such an administrator or law enforcement personnel. Activating the chat button 218 enables the user to communicate with an administrator or law enforcement via SMS text. Activating this button 218 opens a chat box and the user is able to type his or her message and send it to the administrator or authorities. The user may then receive an administrator's or law enforcement authority's response in the chat box.

With continuing reference to FIG. 7, an emergency alert icon or button 220 may be provided and displayed on the touchscreen 202. This enables the administrator or law enforcement personnel to send an emergency alert or message to the user. Such will be indicated by a change of color, a flashing light, or the like to alert the user that the administrator or law enforcement personnel has sent an emergency alert or message to the user. When the user presses this button, another window may open to show such communication which has been initiated by the administrator or law enforcement personnel.

The present invention may be used to send an emergency alert signal to the administrator or to law enforcement of not only a crime by a perpetrator against the user in real time, but to report any crime which is occurring at the location of the user. In this case, the user would select and activate the “report a crime” emergency button 206. Similar steps, as described above, could automatically take place. This would include automatically acquiring GPS location data from the GPS receiver of the mobile computing device of the user and automatically transmitting from the mobile computing device to an administrator computing device the GPS location data of the mobile computing device and notification that a crime is currently being committed. This may also include automatically recording of video and/or audio using the camera or recording device of the mobile computing device of the user upon a user touching and activating the emergency button to report a crime such that video and audio recording of the crime being committed is obtained and transmitted to the administrator or law enforcement and saved for later review and potential use by a prosecutor or the like. The evidence gathered by the user using the present invention for law enforcement can be important evidence that may be crucial to a future criminal case. Such reporting information can also be useful to have law enforcement respond and respond appropriately and safely.

One of the emergency buttons 206 may be touched and activated by the user when the user or a person with the user is having a medical emergency or is in need of medical attention. This may be as a result of the crime committed by the perpetrator against the user. Alternatively, it could be as a result of a crime and injury committed against someone other than the user. It could also be used in instances when either the user or a person with the user is having a medical emergency and needs medical attention. In such case, an emergency alert signal is sent to the administrator along with reporting information relating to the user, user's location, etc. The video and/or chat features could be utilized to assist the administrator, law enforcement or medical personnel to assess the severity of the emergency situation and even provide medical guidance before medical personnel arrive at the scene.

One of the emergency buttons 206 may be a “I am lost” button, which the user can activate by pressing the button on the touchscreen 202 to notify the administrator or law enforcement personnel that the user is lost. This may be as a result of the user fleeing the scene of a crime and being lost. The invention also contemplates that it could also be a situation where the user is simply lost and needs assistance. Once again, pertinent information relating to the user, the user's GPS location data, and possibly even a video or audio recording could be sent to the administrator as part of a report to provide emergency assistance to the user. Such emergency assistance may be merely guiding the user to a known or safe location.

When the user is being followed, such as being stalked by an unknown person or even a known person who is of concern to the user, the user can depress a corresponding “being followed” emergency button 206. This can activate any of the foregoing features of the present invention, including automatically sending an alert emergency signal to the administrator. GPS location data of the GPS receiver of the mobile computing device of the user can be transmitted to the administrator or law enforcement. Additionally, a video and/or audio recording may be made which will be automatically sent to the administrator upon the user either selecting the video and audio recording to be sent or after a predetermined period of time, which may vary, but sufficiently short so as to be quickly transmitted and received by the administrator, law enforcement or the like and be able to be more easily and quickly reviewed by the administrator or law enforcement to ascertain the situation. Such information can also be used as evidence in the event that the situation escalates into a crime against the user. Such information can assist law enforcement to respond according to the situation and have information as to the severity of the incident or situation that is occurring with the user.

As shown in FIG. 7, the invention may display on the touchscreen a map and the current location of the user, which may be of assistance to the user in various situations, including if the user is lost or is being followed, is attempting to avoid an area where crime is being committed, or to seek safety or assistance nearby. The software application may also provide an activatable touch button feature 224 which enables the user to zoom in and zoom out of his or her current location on the illustrated map. This could further assist the user in determining where he or she is, where a safe location is, etc.

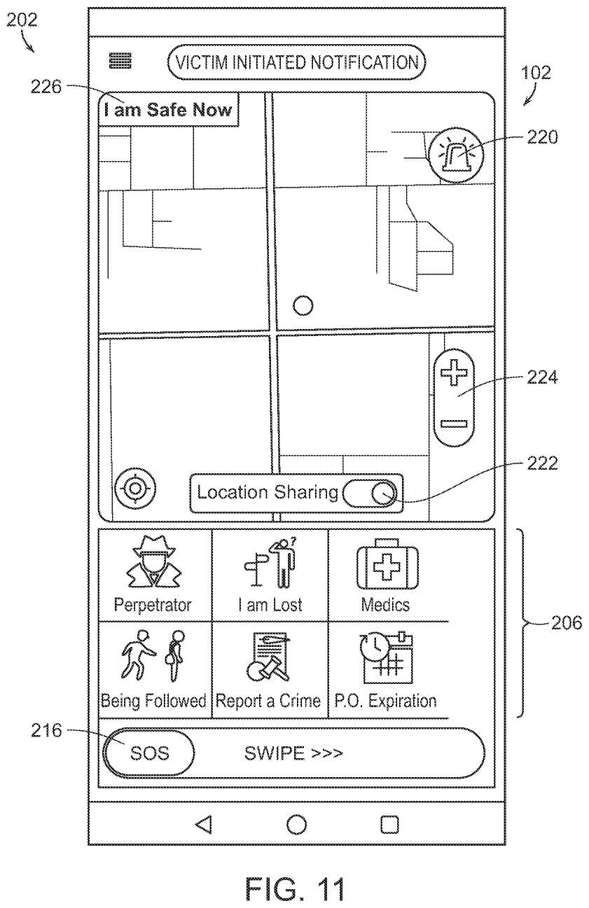

As illustrated in FIG. 11, it is contemplated by the present invention that a “location sharing” button or option may be provided to the user to selectively activate or deactivate the location sharing or the map showing the location of the user. The default, however, is preferably that the user's location is obtained, transmitted, and tracked during the situation. Such tracking occurs with the mobile computing device periodically automatically obtaining GPS location data through its GPS receiver and transmitting the GPS location data to the administrator computing device so as to track the user in real time.

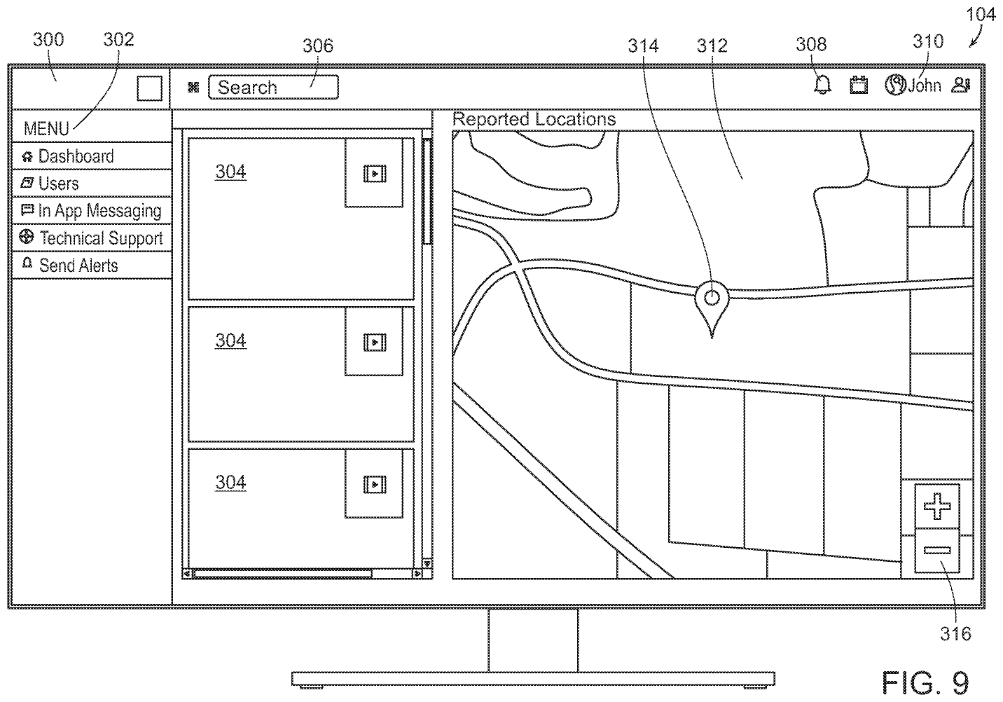

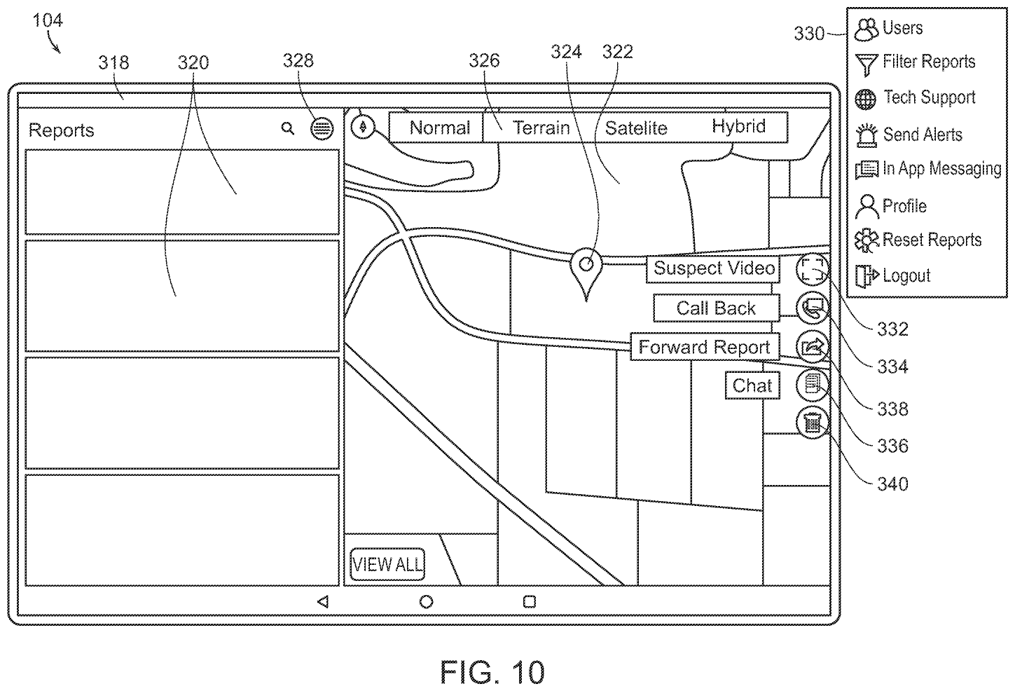

With reference now to FIG. 9, an exemplary administrator computing device 104 is shown. This may be in the form of a desktop computer and monitor, as illustrated in FIG. 9, a laptop, a handheld mobile computing device, such as the tablet illustrated in FIG. 10, or the like. As mentioned above, the administrator computing device 104 receives emergency alert signals, reports, messages, video and audio files and the like from users of the system of the present invention who are experiencing an emergency. Thus, the one or more administrator computing devices 104 are linked via an appropriate network, such as a cellular network, internet, satellite communication, etc. to the mobile computing devices of the various users using the system.

The one or more administrator computing devices, which incorporate the software application embodying the present invention, may comprise a non-law enforcement administrator who receives reports from users, reviews and filters such information, and forwards necessary information and alerts to relevant law enforcement agencies. Alternatively, the administrator may comprise one or more law enforcement agencies, where the information from the user is sent directly to a law enforcement agency, such as a dispatcher, who can then send police or medical emergency assistance, as needed, and provide pertinent information to such law enforcement officers and medical care providers based upon the information received from the user. Regardless, the administrator's or law enforcement's software application and system enables the administrator or law enforcement to receive and store user reports, GPS location, messages, user information, and other emergency information, and as necessary communicate directly with the user in real time.

The invention contemplates a super administrator which is the provider or owner of the system and application which manages the administrative accounts and adds new departments from the desktop portal. The super administrator can create departments from the desktop portal, accept or reject new administrator accounts requested from the portal, and manage administrator's department accounts. An administration department may send alerts to the users, track live locations with GPS coordinates of users when the emergency report is activated. The administrative department may also block or unblock users. The administrative department may search specific reports. The administrative department may chat or communicate with the victim. Upon an incoming emergency report, a loud audio signal alerts the administrator of an emergency report by the user. Preferably, the administrator is able to login to the desktop portal from anywhere. The administrative department is able to share reports with assigned personnel and complete details of an emergency report and manage other users.

With reference again to FIG. 9, an exemplary screenshot is shown of a screen 300 of an administrator computing device 104. Activatable buttons or windows may include a menu 302 which may include a dashboard, button or managing users, in application messaging with users, technical support, and sending alerts to the users. Windows 304 may be provided which show one or more current user reports, which provides the type of alerts, the report details, and the video/audio files, if sent by the user during their emergency situation. A search bar 306 may be provided to the administrator for searching various items, including individual user reports, or other aspects and functionality of the software application system of the invention to assist the administrator. An icon 308 may be provided which visually and/or audibly notifies the administrator of new user emergency alert signals and reports and the like. Indicia 310 may be provided to show the administrator which report or report information or location data is currently being viewed by the administrator. A map 312 may be displayed to the administrator to show the GPS location 314 of the user in question. The map can be altered between street view, terrain view, satellite view, etc. as needed. Selectable buttons 316 may enable the administrator to zoom in and out of the map to more clearly see where the user location is with respect to other areas to provide assistance to the user or in directing law enforcement or medical personnel to arrive to the user in need.

With reference now to FIG. 10, as described above, the administrator computing device may alternatively comprise a handheld mobile computing device, such as a tablet or the like. Such table will have pertinent software application downloaded thereon and receive the emergency signal alerts and related data either directly from the user or from an administrator, which may be a law enforcement dispatcher or the like.

On the display screen 318, which is typically a touchscreen or the like, one or more user emergency reports 320 may be illustrated. Pertinent information for use by the administrator or law enforcement or medical care provider may be provided relating to the user and the user's emergency situation. A digital map 322 is shown with the identification of the location 324 of the user in question on the map. Once again, the administrator or law enforcement or medical personnel may be able to switch the type of view of the map with selectable buttons 326 relating to normal street mode, terrain mode, satellite, hybrid, etc.

A menu icon or button 328 may be selectively activated, which opens a window 330 providing a variety of menu options, including being able to select between users, filtering reports, requesting tech support, sending alerts, messaging in application with the user, viewing the user's profile, etc. A button or icon may be presented on the screen 318, including a button 332 which enables the administrator, law enforcement or medical personnel to view a suspect video. This can be helpful in ascertaining the current situation, the type of crime being committed, the severity of the situation, whether there is a weapon associate with the crime, the identity of the perpetrator of the crime, etc. to assist the law enforcement personnel in responding appropriately and safely.

Activatable touch buttons or icons 334 and 336 may enable the administrator, law enforcement or medical personnel to call back a user or an administrator who sent the report to the law enforcement personnel or medical care provider, or directly message with the user, administrator, etc.

A button or icon 338 may also be provided which enables an administrator to forward a report, such as to a law enforcement agency, such as a dispatcher, or directly to law enforcement personnel or medical care providers. Alternatively, a law enforcement personnel or medical care provider could forward the report to another law enforcement personnel or medical care provider who is either geographically closer to the user experiencing the emergency or are better equipped to handle the situation that the user finds himself or herself in. The video can be downloaded or saved onto a hard drive or external storage to law enforcement in charge of a scene or call.

A delete report button or icon 340 may also be provided so that the administrator, law enforcement personnel and/or medical care provider could delete a received report. This may be the case if the user's situation has been addressed and resolved, the user's report has been forwarded to law enforcement dispatch, law enforcement personnel and/or medical emergency personnel, etc.

In any event, however, it is contemplated by the present invention that emergency alert reports, with pertinent information, including any video/audio evidence is saved, at least temporarily, for future use and reference. As described above, this is preferably done remotely from the user's mobile computing device 102, such as at an administrator's or law enforcement's office, on the cloud, etc. Such a report that is saved may be for any particular user and may be searched for in the future which may be able to be used for a variety of purposes, including evidence by prosecutors in future criminal prosecution, etc. Storing the user reports remotely, such as being cloud-based, may act as a safety feature for the user whose perpetrator may view his or her phone to determine if any pictures or videos have been taken and stored on the user's phone. Such remote storage also protects the evidence and prevents it from being destroyed, such as if the user's mobile computing device 102 is damaged or destroyed. It also prevents the victims from sharing on social media the video, audio, test messages, or other report information which may hinder the investigation.

The audio and video recording, with GPS coordinates, will help investigators with each individual case. This can help gather evidentiary information against the perpetrator, giving the victims confidence and the determination to follow through with court proceedings. This aspect of the system will also help law enforcement and prosecutors to put their cases together with the ability of downloading the evidentiary data and attaching it to the case to either be sent to the prosecutor's office or as evidence in a criminal case. This will help victims from being re-victimized by law enforcement, investigators, advocates and prosecutors by having to prove that he or she was a victim and that the events alleged actually occurred.

The system of the present invention could be utilized to alert law enforcement against various crimes, including domestic violence, sexual assault, harassment, stalking, bullying, etc. It provides the victim a discreet way to record criminal activity which is stamped in real time with date and location information. GPS coordinates of where the alert was activated along with an alert is sent to dispatchers of the law enforcement center where the victim is registered, allowing dispatchers to summon law enforcement for help, sending law enforcement to the victim's GPS location. If the victim leaves the scene, the dispatcher can track the victim as long as the victim has the app open and activated, allowing for law enforcement to locate the victim. In life and death instances, the dispatcher can dispatch an ambulance to stand by the location to help the victim once law enforcement secures the area. In a severe case, an officer will arrive at the scene, stop the threat, evaluate the situation and call for an ambulance. This may be able to be ascertained in advance with the dispatcher evaluating the situation by viewing the sent video. If the dispatcher sees a weapon, such as a gun, knife or other object that can cause severe bodily injury or death, this information can be forwarded on to responding law enforcement and if an injury is viewed then an ambulance or other medical care may be summoned.

As mentioned above, calling 911 or others for help is sometimes not an option when a perpetrator is within range of the victim. Therefore, discreetly alerting for help may stop the situation from escalating and allow law enforcement to catch the perpetrator before he leaves the location. When law enforcement arrives, they already have evidentiary data and it can be used to secure an arrest.

It is known that domestic violence calls are high-risk calls for law enforcement, and they have a tendency to turn violent and dangerous within seconds. The system of the present invention could give insight of the lethality or severity of the situation before the responding officers arrive on scene. This can assist the responding officers in preparing and responding appropriately.

With reference now to FIG. 11, an exemplary screenshot of a touch display screen 202 of a user's computing device 102 is shown. Once the user has recovered from the emergency situation, such as the perpetrator committing a crime against him or her leaving, the user successfully fleeing the perpetrator, the user moving a safe distance from a crime being committed, or the user receiving appropriate law enforcement and/or medical care, the user may select a button 226 to send a notification and signal to the administrator, such as at the administrator computing device 104 that the user is safe now. By sending the “I am safe” alert report law enforcement will scale down the call from emergency to non-emergency, but will still typically respond for the safety of the officer and the public reducing liability. If there is any question or doubt as to whether the user is actually safe, the administrator may correspond in real time with the user, such as by telephone, SMS chat feature, or even requesting a video recording be made by the user and sent to the administrator. The administrator may even send a law enforcement or medical care provider to the user to confirm that the user is in fact safe and there is no longer an emergency situation. The administrator may finalize a report, collect and gather the information provided by the user during the event for storage, and close the user's report as being current or active.

Although several embodiments have been described in detail for purposes of illustration, various modifications may be made without departing from the scope and spirit of the invention. Accordingly, the invention is not to be limited, except as by the appended claims.

What is claimed is:

1. A method for emergency notification, comprising the steps of:
providing at least one touch activatable emergency button through a touchscreen display of a mobile computing device;
automatically acquiring GPS location data from a GPS receiver of the mobile computing device when the at least one emergency button is touched and activated; and
automatically transmitting from the mobile computing device to an administrator computing device the GPS location data of the mobile computing device.

2. The method of claim 1, including the step of providing emergency assistance to the user.

3. The method of claim 1, including the step of tracking the mobile computing device by periodically automatically obtaining GPS location data through the GPS receiver of the mobile computing device and transmitting the GPS location data to the administrator computing device.

4. The method of claim 1, including the steps of automatically recording a video using a camera of the mobile computing device upon a user touching and activating the at least one emergency button and after a predetermined period of time, automatically transmitting from the mobile computing device to an administrator computing device the recorded video.

5. The method of claim 4, wherein the at least one emergency button is activated by the user to report a crime in real time.

6. The method of claim 4, including the step of storing the recorded video received by the administrator computing device on a storage medium physically separate from the mobile computing device.

7. The method of claim 2, wherein the at least one emergency button is touched and activated by the user when the user is lost.

8. The method of claim 2, wherein the at least one emergency button is touched and activated by the user when the user or a person with the user is having a medical emergency.

9. The method of claim 2, wherein the at least one emergency button is touched and activated by the user when the user or a person with the user is concerned about being followed.

10. The method of claim 1, including the step of providing a touch activatable button through the touchscreen display of the mobile computing device that the user activates to transmit a message to the administrator computer that the user is safe.

11. The method of claim 1, including the steps of inputting and storing on the mobile computing device user emergency contacts, and automatically sending an alert to the user emergency contacts when the user activates the at least one emergency button.

12. The method of claim 1, including the steps of inputting and storing protective order information on the mobile computing device and automatically notifying the user when the protective order expires.

13. An emergency notification system, comprising:
a mobile computing device having live transmissible location data and activation means for selectively transmitting an emergency signal;
a video and/or audio recorder associated with the mobile computing device;
means for automatically activating the video and/or audio recorder when transmitting an emergency signal;
means for automatically accessing GPS location data from a GPS receiver of the mobile computing device; and
after a predetermined period of time following initial transmission of the emergency signal, automatically transmitting from the mobile computing device recorded video and/or audio data and location data of the mobile computing device to a remote data storage location.

14. The system of claim 13, including means for tracking the location of the mobile computing device by periodically automatically obtaining GPS location data through the GPS receiver of the mobile computing device and transmitting the GPS location data to an administrator computing device.

15. The system of claim 13, wherein the activation means comprises at least one touch activatable button through a touchscreen of the mobile computing device.

16. The system of claim 15, wherein the at least one touch activatable button is activated by a user to report to an administrator computer that a crime is being committed in real time.

17. The system of claim 15, wherein the at least one touch activatable button is activated by a user when the user is lost or being followed.

18. The system of claim 15, wherein the at least one touch activatable button activated by a user when the user or a person with the user is having a medical emergency.

19. The system of claim 13, including means for inputting and storing on the mobile computing device user emergency contacts, and automatically sending an alert to the user emergency contacts when the emergency signal is transmitted.

20. The system of claim 13, including means for inputting and storing protective order information on the mobile computing device and automatically notifying when the protective order expires.
